(19) United States
(12) Patent Application Publication
(10) Pub. No.: US 2026/0127984 A1
(43) Pub. Date: May 7, 2026

(54) ARTIFICIAL MODEL FOR SIMULATING GRALLOCHING OR GUTTING GAME ANIMALS

(71) Applicants: Jerome Otto Schorr, III, White Hall, MD (US); Anitra Kareen Schorr, White Hall, MD (US)

(72) Inventors: Jerome Otto Schorr, III, White Hall, MD (US); Anitra Kareen Schorr, White Hall, MD (US)

(21) Appl. No.: 19/382,360

(22) Filed: Nov. 7, 2025

Related U.S. Application Data
(60) Provisional application No. 63/717,287, filed on Nov. 7, 2024.

(51) Int. Cl. G09B 23/36

(52) U.S. Cl. CPC G09B 23/36

(57) ABSTRACT

An animal model having an abdominal cavity that is sealed via a simulated incision. The simulated incision may be secured in a closed position using a zipper, buttons, magnets, or hook and loop fasteners. Internal organs are removably received in the abdominal cavity. These organs are retained in anatomically correct positions via accurate placement in the abdominal cavity. The secured simulated incision enables the user to open the animal model in the necessary sequences and positions associated with properly gralloching or gutting the animal. The individual organs can be removed from the cavity in the proper sequence and position to assist with the education of the user. The organs can be reinserted and the simulated incision secured so that the process can be repeated as necessary to promote hunting and fishing education and conservation practices.

### PRIORITY TO RELATED APPLICATIONS

The present application claims priority to U.S. provisional application Ser. No. 63/717,287 filed 7 Nov. 2024.

### BACKGROUND OF THE INVENTION

### 1. Field of the Invention

During the training of students or hunting and fishing practitioners, hands-on preparation of the carcass following the harvesting of the animal is essential to obtain and preserve meat and to instill good sportsmanship and conservation practices. The standard for such training has been the use of recently killed animals in the field, which is often in less-than-ideal conditions. Also, the risks associated with the use of fresh cadavers including risks relating to the exposure to biohazards, for example, diseases transmitted by parasites and bacteria, present a disadvantage of using fresh animal carcasses for training purposes. In addition, the harvesting of the animal via gunshot, arrow, or other hunting implement may introduce damaging changes to the mechanical properties of the target anatomy that limit how effective they are as a teaching tool. The present invention relates in general to a physical model for teaching someone how to field dress or gut a game animal, such as deer, moose, elk, bear, big cat, wild pig, turkey, squirrel, fish, crab, etc. Prior art addresses various tools that are useful for field dressing game animals. However, difficulty has been found in addressing proper simulation of the use of these tools without the development of models that represent the animals themselves.

### 2. Description of the Background

Various types of anatomically constructed models for educational purposes are known in the prior art. The conventional use of these models is to illustrate various internal organs and structural components of humans and other animals for medical instruction. A typical example of such a model is to be found in U.S. Pat. No. 11,528,241, which issued to Christopher Sakezles and David Danielson on Aug. 16, 2022. This patent discloses an educational model for training veterinarian students on a simulated canine with various internal organs. U.S. Pat. No. 4,822,285, which issued to Stephan W. Summerville on Apr. 18, 1989, discloses a stuffed toy animal with a cavity covered by a dorsal access flap and stuffed with removable internal organs located in their approximately anatomically correct positions, the access flap being secured by a zipper or by hook and loop fasteners. U.S. Pat. No. 10,885,813, which issued to Todd J. Krummenacher, et al on Jan. 1, 2021, discloses a human body model for temporary hemorrhage control training and simulation.

Various methods and apparatus that assist with field dressing and gutting game animals are known in the prior art. For example, U.S. Pat. No. 9,504,261, which issued to Joseph Wayne Collins on Nov. 29, 2016, discloses an apparatus that is useful for removing internal organs from a game animal. U.S. Pat. No. 5,462,479, which issued to Michael L. Hajek on Oct. 31, 1995, discloses a wild game dressing tool that offers an easy way to split an animal's pelvic bone. In addition, U.S. Pat. No. 3,241,236, which issued to James P. Capps on Mar. 3, 1966, discloses a game knife that is especially designed to perform the inherently complicated operations required for properly dressing game animals including fish, birds, crab, small game, and the large four-legged animals such as deer, moose and elk.

While the above mentioned devices are suited for their intended usage, none of these devices provide an artificial animal model having an abdominal cavity filled with organs that are representative of those associated specifically with gralloching or gutting and closed by a zippered or hook and loop opening that simulates the accurate opening that should be created solely for the unique purpose of entering the animal to remove its organs. The prior art provides wide openings to the interior of the devices with the goal of most beneficially viewing the internal components, but none of the openings are access points that are representative of the specific cuts that are ideal for removing the organs without unwanted damage to both the organs and the animal during the gralloching or gutting process. Thus, it would be greatly advantageous to provide such an anatomically correct model that can be practiced on by those in a safe environment instead of in the random unpredictable conditions often encountered while procuring said animals in the wild and to promote good conservation practices via education.

### SUMMARY OF THE INVENTION

In view of the foregoing disadvantages inherent in the known types of animal models now present in the prior art, the present invention provides improved anatomically correct artificial game animal models.

It is another object of the present invention to provide simulated incision locations that can be closed and opened in relation to the process of gralloching or gutting game animals.

Another object of the present invention is to provide a model with a hollow abdominal cavity in which representations of the animal's internal organs are removably received.

Still another object of the present invention is to provide internal organs that represent those organs that will be removed during the gralloching or gutting process.

Yet another object of the present invention is to provide a new and improved anatomically filled animal model that is an educational device for instructing children and adults on the anatomical characteristics and proper procedures involved with the gralloching or gutting process of game animals.

An even further object of the present invention is to provide a new and improved anatomically filled animal model which is susceptible of a low cost of manufacture with regard to both materials and labor, and which accordingly is then susceptible of low prices of sale to the consuming public, thereby making such demonstrable animal models economically available to the buying public.

As such, the general purpose of the present invention is to provide a new and improved anatomically filled animal model with representative game animal organs and simulated incisions which has all the advantages of the prior art models and none of the disadvantages.

In accordance with the foregoing objects, the invention is an animal model with a hollow cavity filled with internal organs that are removably received and an incision that may be secured in a closed position through the use of a zipper, buttons, magnets, or hook and loop fasteners. The secured incision may allow the user to open the wild game model in the necessary sequences associated with properly gutting the animal. Similarly, the individual organs can be removed from the cavity in the proper sequence to assist with the education of the user. The organs can be reinserted, and the incision can be secured again so that the process can be repeated as many times as is necessary. A hunter can learn the proper techniques for gralloching or gutting an animal in the safety of a comfortable environment before encountering unknown and potentially unsafe conditions in the field as he or she might have to with the prior art.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 shows a side view of the exemplary anatomically filled animal in accordance with the preferred embodiment of the present invention.

FIG. 2 shows a bottom view of the ventral side of the anatomically filled animal model according to the first embodiment of the present invention with the simulated incision in the closed position.

FIG. 3 shows a bottom view of the ventral side of an anatomically filled animal model according to a first embodiment of the present invention with the simulated incision in the open position and the internal organs visible inside the cavity.

FIG. 4 shows a perspective view of the anatomically filled animal model according to FIG. 1 with the simulated incision in the open position and the internal organs removed, the organs being displayed adjacent to the animal model.

FIG. 5 shows a side view of an anatomically filled fish model in accordance with a second embodiment of the present invention.

FIG. 6 shows a bottom view of the ventral side of the anatomically filled fish model of FIG. 5 with the simulated incision in the closed position.

FIG. 7 shows a bottom view of the ventral side of the anatomically filled fish model of FIGS. 5-6 with the simulated incision in the open position and the internal organs visible inside the cavity.

FIG. 8 shows a perspective view of the anatomically filled fish model of FIGS. 5-7 with the simulated incision in the open position and the internal organs removed, the organs being displayed adjacent to the fish model.

### DETAILED DESCRIPTION OF THE PREFERRED EMBODIMENT

The present invention is an animal model with a hollow cavity filled with internal organs that are removably received and a simulated incision that may be secured in a closed position through the use of a zipper, buttons, magnets, or hook and loop fasteners. The secured incision may allow the user to open the model in the necessary locations and sequences associated with properly gutting the animal. Similarly, the individual organs can be removed from the cavity in the proper sequence, order, and location to assist with the education of the user. The organs can be reinserted, and the simulated incision can be secured again so that the process can be repeated as many times as is necessary.

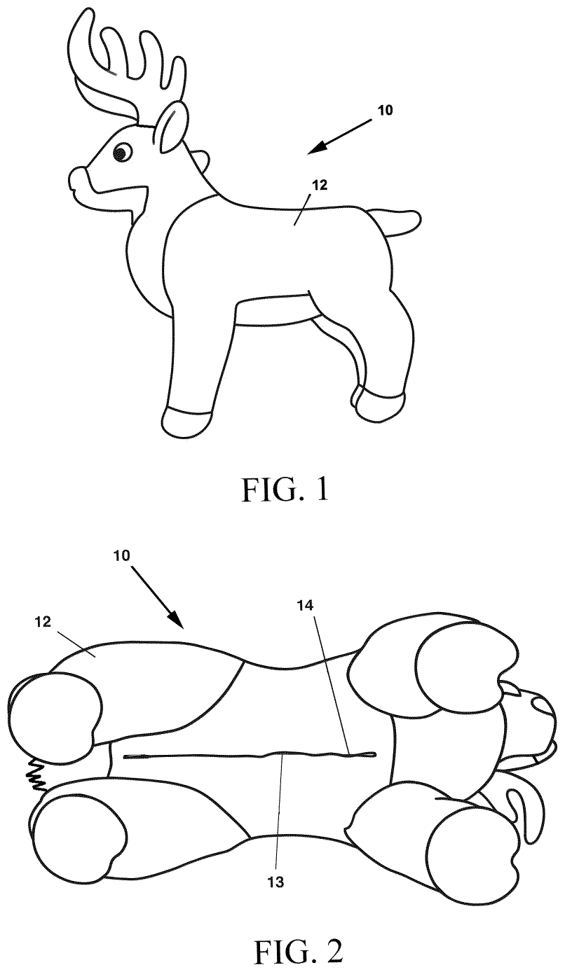

FIG. 1 shows the new and improved animal model 10 according to a first embodiment of the present invention in the form of a male deer, generally including a body portion 12. The body portion 12 may be in the shape of any desired animal such as a deer, moose, elk, bear, big cat, wild pig, turkey, squirrel, fish, crab, etc. The body 12 of the animal model is formed in a conventional fashion by providing unitary solid molded plastic or rubber, or an outer shell formed of a fabric or molded plastic or rubber covering optionally stuffed with a filler material. The materials may be of any conventional form without departing from the scope of the present invention.

FIG. 2 shows a view of the ventral side of the body 12 of the animal model 10 of FIG. 1. The body 12 of the animal model 10 has a hollow abdominal cavity with a simulated midline incision 13 that follows the center of the abdomen along the linea alba. Incision 13 may be selectively opened or closed by hook and loop fasteners 14 that run along the length of the simulated incision 13. The hook and loop fasteners 14 may be positioned in predetermined locations or may run the entire length of the simulated incision 13.

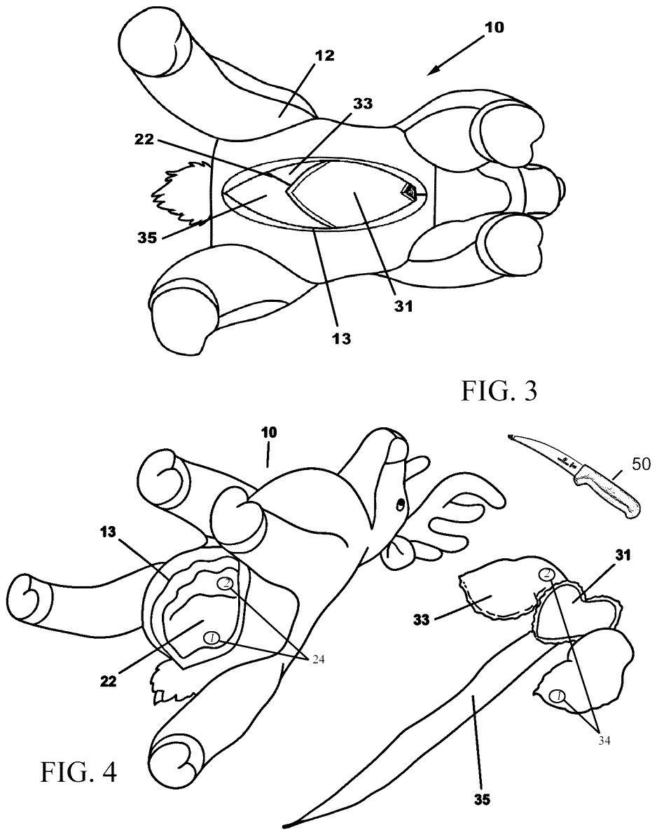

FIG. 3 is a view of the ventral side of the animal model 10 with the simulated incision 13 in an open position. A plurality of internal organs of an animal 31, 33, 35 are removably retained in the hollow abdominal cavity 22 of the body 12. These organs may include a heart 31, lungs 33, intestines 35, and any other body parts considered disposable guts that should be removed when cleaning the animal. The heart 31, the smallest of the representative organs, is in the chest of the animal model 10. The lungs 33 occupy approximately a third of the abdominal cavity 22 and generally surround the heart, and may also include a long structure representing the esophagus running the entire length of the abdominal cavity 22. The remaining lower portion of the abdominal cavity 22 is filled with the intestines 33 which occupy the remainder of the abdominal cavity. These various internal organs are removably retained in their approximate anatomically correct locations within the body 12 by interference fit or by cooperating hook and loop fasteners on the back of each of the organs and on the inner wall of the hollow abdominal cavity 22. Thus, these various stuffed organs may be selectively removed and replaced for educational purposes as the sequential field dressing or gutting simulation takes place.

As seen in FIG. 4, the simulated incision 13 is in an open position and internal organs, including the heart 31, lungs 33, and intestines 35 are removed from the hollow abdominal cavity 22 of the animal model 10.

In an embodiment the hollow abdominal cavity 22 of the animal model 10 may be imprinted with identifying indicia 24 positioned along its inner surface and corresponding to identifying indicia 34 on the exterior surfaces of each organ 31, 33, 35 to indicate an ideal order and specific locations to proceed when simulating gutting said animal. In addition, a simulated gutting knife 50 may be provided for selectively opening the simulated incision 13.

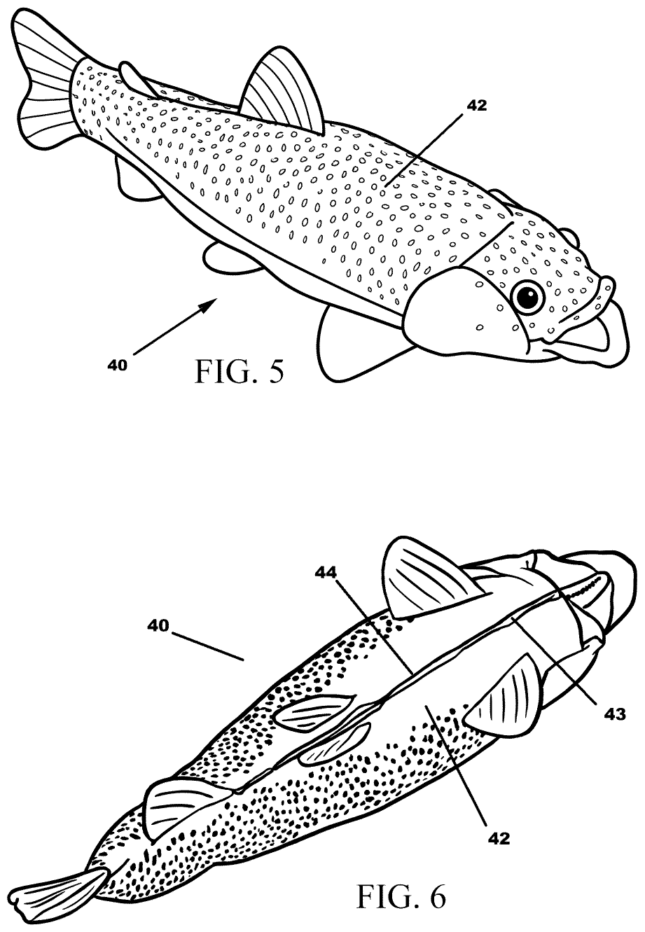

FIG. 5 shows an anatomically filled fish model 40 in accordance with a second embodiment of the present invention, fish model 40 including a body portion 42. The body 42 of the fish model is formed in a conventional fashion by providing unitary solid molded plastic or rubber, or an outer shell formed of a fabric or molded plastic or rubber covering optionally stuffed with a filler material. The materials may be of any conventional form without departing from the scope of the present invention.

FIG. 6 shows a view of the ventral side of the body 42 of the fish model 40 according to the first embodiment of the present invention. The body 42 of the fish model 40 has a hollow abdominal cavity with a simulated midline incision 43 that follows the center of the abdomen along the ventral midline (fish have a structure that is analogous to the mammalian linea alba, which serves as the key anatomical landmark, it is a line of connective tissue that runs along the mid-ventral line of the abdomen, separating the left and right muscle masses). Incision 43 may be selectively opened or closed by hook and loop fasteners 44 that run along the length of the simulated incision 43. The hook and loop fasteners 44 may be positioned in predetermined locations or may run the entire length of the simulated incision 43.

The hook and loop fasteners 44 may be positioned in predetermined locations or may run the entire length of the simulated incision 43.

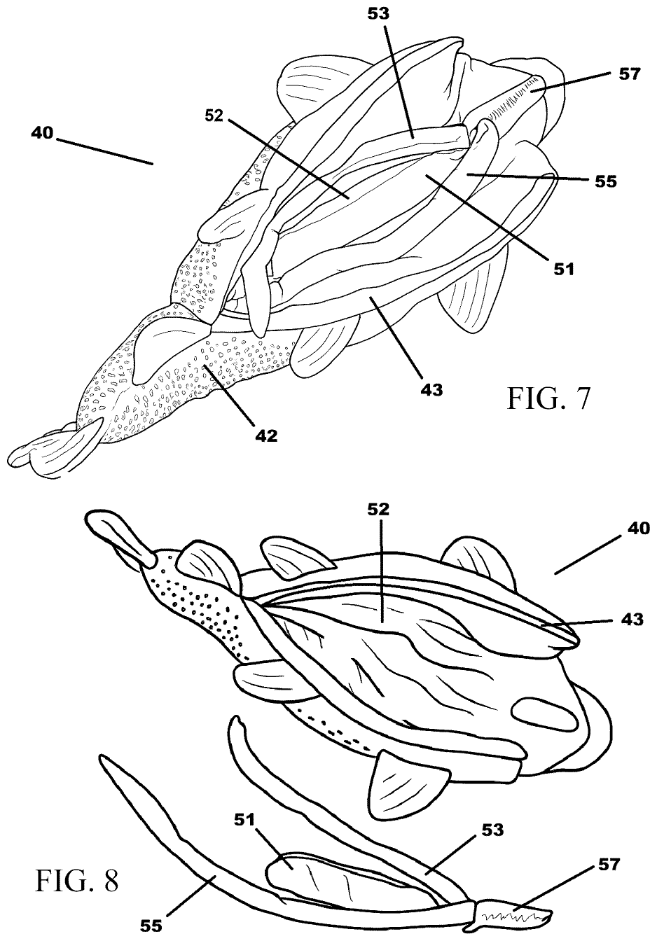

FIG. 7 is a view of the ventral side of the fish model 40 with the simulated incision 43 in an open position. A plurality of representations of the internal organs of a real fish are removably retained in the hollow abdominal cavity 52 of the body 42. These organs may include a heart 51, swim bladder 53, intestines 55, and any other body parts considered disposable guts and lower jaw 57 that should be removed when cleaning the animal. The heart 51, the smallest of the representative organs, is in the chest of the fish model 40 nearest the head. The swim bladder 53 occupies approximately a third of the abdominal cavity 52 and is located in the dorsal portion of the abdominal cavity 52. The remaining ventral portion of the abdominal cavity 52 is filled with the intestines 55, which occupy the remainder of the abdominal cavity. These representative organs may all be attached to the lower jaw 57 so that they can all be removed in one connected piece to accurately simulate the process used when cleaning the animal where the lower jaw 57 is pulled from the body 42 and the organs come out with the lower jaw 57. These various internal organs are removably retained in their approximate anatomically correct locations within the body 42 by interference fit or by cooperating hook and loop fasteners on the back of each of the organs and on the inner wall of the hollow abdominal cavity 52. Thus, these various stuffed organs may be selectively removed and replaced for educational purposes as the sequential field dressing or gutting simulation takes place.

As seen in FIG. 8, the perspective view of the fish model 40 with the simulated incision 43 in an open position includes a plurality of internal organs, including the heart 51, swim bladder 53, and intestines 55 that have been removed from the hollow abdominal cavity 52 along with the lower jaw 57 attached to the entrails of the fish model 40.

While the securement of the various organs and the incision have been described with reference to hook and loop fasteners, which is the preferred method, various other fastening means such as zippers, snaps, magnets, cooperating tabs and slots, etc. may be utilized without departing from the scope of the present invention.

Although the models described above have been primarily associated with game animals such as fish, deer, moose, elk, bear, big cat, wild pig, turkey, squirrel, crab, etc., various other embodiments of creatures and internal structures to be removed such as bones, brains, muscles, etc. are not excluded from the present invention. These may include cryptids, aliens, ghosts, monsters, mythical beasts and imaginary creatures that can be produced with internal structures that can be removed and reinserted to simulate gralloching.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. In all such cases, the result is a more aesthetically pleasing or customized for appearance or practical, functional purposes model useful in simulating gralloching or gutting game animals in a commercially manufacturable configuration that modifies the aesthetics and/or appearance while preserving the integrity and functional structure of the model so as not to depart from established standards.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. An animal model with internal organs and a securable simulated incision comprising:
a body portion comprising a model of a game animal body from among the group of a deer, moose, elk, bear, big cat, wild pig, turkey, squirrel, fish, and crab;
a hollow abdominal cavity in said body portion;
a plurality of internal organs removably received in said abdominal cavity;
a simulated incision for selectively closing said abdominal cavity; and
fastening means for securing said simulated incision in a closed position.

2. The animal model with internal organs and a securable simulated incision of claim 1, wherein said body portion and plurality of internal organs are further comprised of imprinted indicia on said surfaces of said model and organs indicating an ideal order and locations to proceed when simulating gutting said animal.

3. The animal model with internal organs and a securable simulated incision of claim 1, further comprising a simulated gutting knife for selectively opening said simulated incision.

4. The animal model with internal organs and a securable simulated incision of claim 1, wherein said body portion and organs are made of rubber.

5. A non-human anatomical model for gralloching training, comprising:
a body portion configured externally in the shape of a non-human animal and having a hollow internal cavity configured to simulate a non-human animal's abdominal cavity, said hollow internal cavity being externally accessible along a selectively openable and closable slit configured as a simulated midline incision lengthwise along said animal's abdominal cavity; and
a plurality of inserts each configured externally in the shape of a non-human animal's internal organ, each dimensioned to fit through said slit, and all of said plurality of inserts collectively dimensioned to nest within said hollow internal cavity and simulate said animal's internal organs in said abdominal cavity.

6. The non-human anatomical model for gralloching training according to claim 5, wherein said non-human animal is any one from among a group of crustacean, fish and mammal.

7. The non-human anatomical model for gralloching training according to claim 5, wherein said body comprises a unitary solid molded body.

8. The non-human anatomical model for gralloching training according to claim 5, wherein said body comprises an outer shell.

9. The non-human anatomical model for gralloching training according to claim 5, wherein said non-human animal is a non-human mammal and said selectively openable and closable slit is configured as a simulated midline incision lengthwise along said mammal's abdominal cavity.

10. The non-human anatomical model for gralloching training according to claim 5, wherein said body comprises a fastener for securing said slit in a closed position.

11. The non-human anatomical model for gralloching training according to claim 10, wherein said fastener comprises a zipper.

12. The non-human anatomical model for gralloching training according to claim 10, wherein said fastener comprises a hook-and-loop fastener.

13. The non-human anatomical model for gralloching training according to claim 10, wherein each of said plurality of inserts includes a hook-and-loop fastener.

14. A non-human mammalian anatomical model for gralloching training, comprising:
a body portion configured externally in the shape of a non-human mammal and having a hollow internal cavity configured to simulate a non-human mammal's abdominal cavity, said hollow internal cavity being externally accessible along a selectively openable and closable slit configured as a simulated midline incision lengthwise along said mammal's abdominal cavity; and
a plurality of inserts each configured externally in the shape of a non-human mammal internal organ, each dimensioned to fit through said slit, and all of said plurality of inserts collectively dimensioned to nest within said hollow internal cavity and simulate said mammal's internal organs in said abdominal cavity.

15. The non-human anatomical model for gralloching training according to claim 14, wherein said body comprises a unitary solid molded body.

16. The non-human anatomical model for gralloching training according to claim 14, wherein said body comprises an outer shell.

17. The non-human anatomical model for gralloching training according to claim 14, wherein said selectively openable and closable slit is configured as a simulated midline incision lengthwise along said mammal's abdominal cavity.

18. The non-human anatomical model for gralloching training according to claim 17, wherein said body comprises a fastener for securing said slit in a closed position.

19. The non-human anatomical model for gralloching training according to claim 17, wherein said fastener comprises one of a zipper or a hook-and-loop fastener.
